(19) United States
(12) Patent Application Publication
(10) Pub. No.: US 2008/0074245 A1
(43) Pub. Date: Mar. 27, 2008

(54) Method and system for emergency calls from vehicles

(76) Inventors: Marten Wittorf, Ingelheim (DE); Lars Hoffmann, Bralanda (SE); Matthias Hofmann, Stuttgart (DE)

Correspondence Address: HARNESS, DICKEY & PIERCE, P.L.C., P.O. BOX 8910, RESTON, VA, 20195, US

(21) Appl. No.: 11/484,572

(22) Filed: Jul. 12, 2006

(30) Foreign Application Priority Data
Jul. 14, 2005 (SE) 0501666-2

(51) Int. Cl. B60R 25/10

(52) U.S. Cl. 340/426.18; 340/425.5; 340/426.22

(57) ABSTRACT

A method for an emergency call from a vehicle to an alarm centre, including receiving a wireless initiation signal from a portable alarm unit, evaluating the initiation signal, and sending, based on the result of the evaluation, a wireless alarm signal from a vehicle communication system arranged in the vehicle to the alarm centre. If the owner of the vehicle or some other person gets into an emergency, for instance is assaulted, in the immediate surroundings of the vehicle, it is thus possible to send an alarm signal to an alarm centre via the vehicle without first entering it. The personal safety for the individual is therefore increased. In addition, in the case of an assault, the perpetrator can be frightened away by sound and/or light signals emitted by the vehicle.

### FIELD OF THE INVENTION

The present invention relates to a method for an emergency call from a vehicle to an alarm centre.

The invention also concerns an emergency call system for vehicles.

### BACKGROUND ART

Nowadays cars are frequently equipped with alarm systems for deterring thieves and vandals. There are also systems that can be used to alarm, for instance using the horn of the car, in the case of an emergency. Furthermore systems are known which can alarm by contacting an alarm centre via mobile communication.

U.S. Pat. No. 6,310,543 discloses such a system where an alarm system can be activated by a person in the car pressing an emergency call button. With the emergency call button depressed, an emergency call is sent by means of an integrated mobile phone to an alarm centre. The emergency call may include information about the position and travelling direction of the car.

The article “Airbags bei Citroen senden Notruf” in Netzeitung.de of 2 May 2005 describes a similar system for sending an emergency call. This system, which is integrated in a system for navigation, hi-fi and mobile telephony, makes it possible to send an emergency call to an alarm system either automatically in the case of an accident, or by a user pressing a button in the system.

A drawback of these systems is that the availability of the emergency call system is relatively limited. This means that the personal safety for the individual may suffer since the emergency call system cannot be activated in all emergencies.

### SUMMARY OF THE INVENTION

An object of the present invention thus is to increase the availability of an emergency call system.

A further object is to provide improved personal safety for the individual.

These and other objects are achieved by a method and an emergency call system according to claims 1 and 8.

A first aspect of the invention concerns a method for an emergency call from a vehicle to an alarm centre, comprising the steps of receiving a wireless initiation signal from a portable alarm unit, evaluating the initiation signal, and sending, based on the result of the evaluation, a wireless alarm signal from a vehicle communication system arranged in the vehicle to the alarm centre.

The portable alarm unit can be a special alarm unit, or the alarm function can be, for instance, integrated in the remote-control unlocking unit of the vehicle (key, remote control, key card etc).

Based on the result of the evaluation of the initiation signal, the vehicle can also emit sound and/or light signals, for instance by means of the horn and/or the headlamps and/or the interior lighting. By this method an initiation signal is thus wirelessly received from a portable alarm unit. This means that a stationary alarm button, positioned for instance on the dashboard, need not be activated for an alarm signal to be sent to the alarm centre.

If the owner of the vehicle or some other person gets into an emergency, for instance is assaulted, in the immediate surroundings of the vehicle, it is thus possible to send an alarm signal to an alarm centre via the vehicle without first entering it. The personal safety for the individual is therefore increased. In addition, in the case of an assault, the perpetrator can be frightened away by sound and/or light signals emitted by the vehicle.

Moreover, in the case of an accident, it may be difficult for the individuals in the vehicle to reach a stationary button, and therefore wireless initiation using a portable alarm unit results in increased availability of the emergency call system and, thus, increased personal safety for the individuals.

The wireless initiation signal may comprise an identification code which identifies the alarm unit.

By sending together with the initiation signal an identification code, the risk of false alarms can be reduced since the identity of the person who initiates the alarm can be sent on to the alarm centre.

In one embodiment, the step of evaluating the initiation signal comprises the step of identifying said initiation signal as an emergency signal, and allowing emission of a wireless alarm signal in response to a wireless initiation signal from each of a plurality of portable alarm units, the alarm units having different identities.

In this embodiment, an alarm signal can thus be emitted in response to an initiation signal received from each of a plurality of different alarm units. Thus a person who has no relation to a specific vehicle can by means of his portable alarm unit still activate the emergency call system of the vehicle. Of course, also sound and light signals can be emitted from the vehicle.

The technical effect achieved by the present embodiment thus is that each of a plurality of wireless alarm units with different identities, when sending an emergency signal, will access the emergency call system of the vehicle.

An objective problem resulting from said technical effect will thus be: How should a user without relation to a vehicle be allowed to access the emergency call system of the vehicle?

To solve this problem, a person skilled in the art would probably find no clues from the literature about the conventional unlocking remote control of a car. The reason for this is that the work for developing such remote controls has, for obvious reasons, focused on decreasing as much as possible the possibility for users to access a vehicle without precisely the remote control that belongs to the specific vehicle.

Emission of a wireless alarm signal may also be allowed in response to a wireless initiation signal from a portable alarm unit which is related to another vehicle.

The method according to the present invention may further comprise the step of obtaining a safety-related signal from a sensor located in the vehicle.

By “safety-related signal” is meant a signal whose value can provide information about an emergency. Such a signal may be, for instance, one of belt stretching signal, acceleration sensor signal, temperature signal, air-bag signal, tyre pressure signal and engine status signal. It goes without saying that also other signals are conceivable.

The provision of this type of signals allows information about the kind of emergency to be sent to the alarm centre. The activities following the alarm can thus be better adjusted to the current situation.

The step of evaluating the initiation signal may also comprise the step of evaluating the safety-related signal provided.

By evaluating the provided safety-related signal, information about the emergency can in many cases be obtained. Such information can be very useful for the alarm centre.

The alarm signal sent to the alarm centre may comprise information about at least one of the position of the vehicle, the identity of the vehicle, the identity of the alarm unit and information about the emergency.

In this way, the staff of the alarm centre can be given better possibilities of quickly sending the correct assistance to the correct location. This increases the probability of the emergency achieving a successful outcome.

A second aspect of the invention concerns an emergency call system for vehicles, comprising a receiver located in a vehicle and adapted to receive a wireless initiation signal from a portable alarm unit, a control unit connected to the receiver and adapted to send, after evaluation of said initiation signal, an alarm command to a vehicle communication system, the vehicle communication system being adapted to send, in response to said alarm command, a wireless alarm signal to an alarm centre.

### BRIEF DESCRIPTION OF THE DRAWINGS

The present invention will now be described in more detail with reference to the accompanying drawings which by way of example illustrate currently preferred embodiments.

FIG. 1 illustrates an emergency call system of prior-art type.

FIG. 2 illustrates schematically a possible use of the emergency call system according to the present invention.

FIG. 3 illustrates schematically a first embodiment of an emergency call system according to the present invention.

FIG. 4 illustrates schematically a second embodiment of the emergency call system according to the present invention.

FIG. 5 is a flow chart which schematically illustrates a first embodiment of a method according to the present invention.

FIG. 6 is a flow chart which schematically illustrates a second embodiment of the method according to the present invention.

### DETAILED DESCRIPTION OF PREFERRED EMBODIMENTS

The following description concerns an emergency call system in a passenger car. However, the invention can advantageously be used also in other vehicles, such as busses, coaches, motorcycles, lorries, trucks etc.

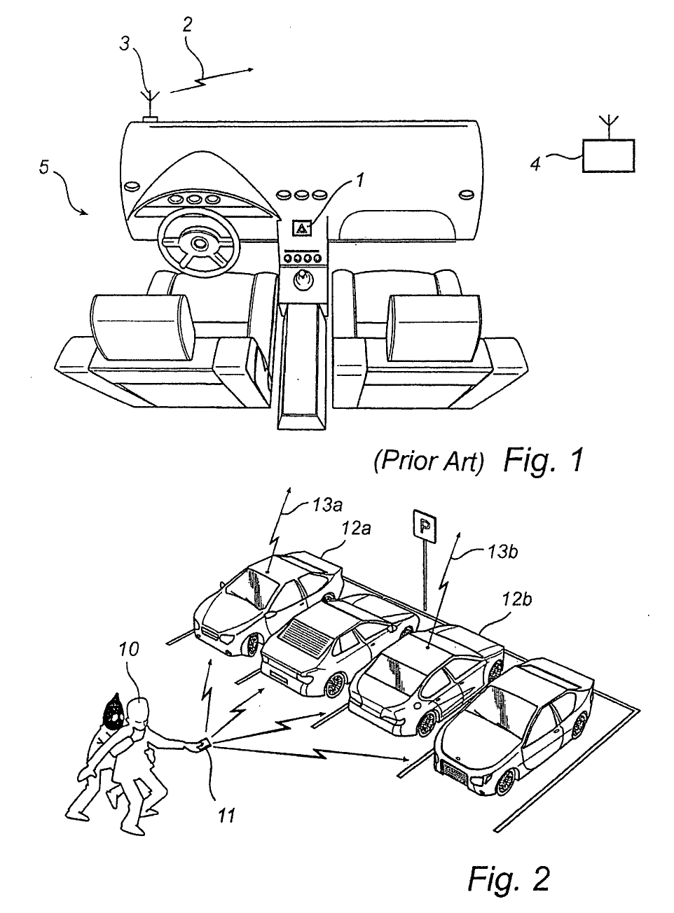

FIG. 1 illustrates a prior-art emergency call system with an alarm button 1 which is fixedly arranged in a car 5. When the driver or a passenger presses the button 1, an alarm signal 2 is generated, which via an antenna 3 on the car 5 is sent to an alarm centre 4.

Such a prior-art emergency call system is not accessible in a situation as illustrated in FIG. 2. FIG. 2 which illustrates a possible use of the emergency call system according to the present invention, shows how an assaulted person 10 can activate, by means of his alarm unit 11, for instance in the form of a key with a remote-control unlocking function, the emergency call system in two cars 12a-b parked nearby. From these cars, signals 13a-b are immediately sent to an alarm centre. The assaulted person 10 can thus by means of an emergency call system according to the present invention quickly and at a distance access the emergency call systems in cars 12a-b parked nearby. The inventive emergency call system integrated in the cars 12a-b thus results in increased personal safety for individuals who have the emergency call system in their own vehicles and their alarm unit 11 available.

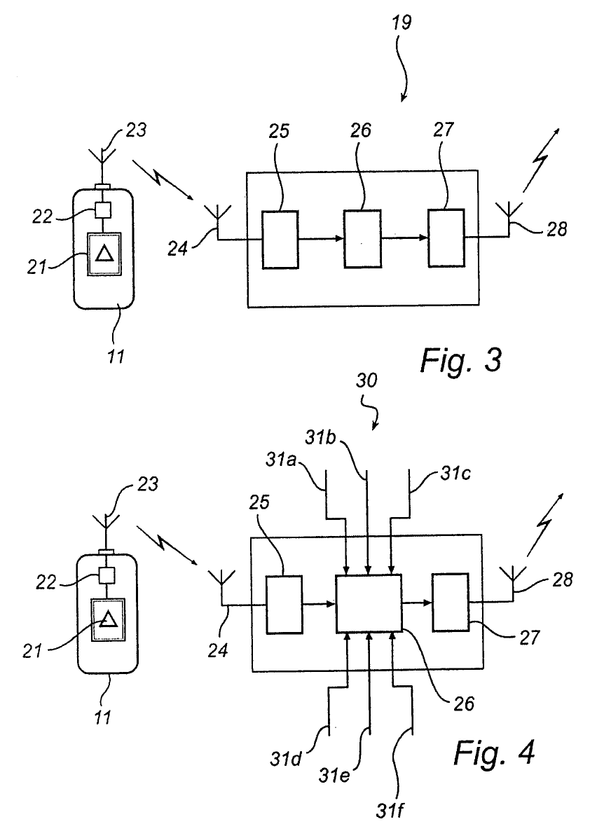

FIG. 3 illustrates schematically a first embodiment of an emergency call system 19 according to the present invention, comprising an alarm unit 11 with an alarm button 21, a radio transmitter 22 and an antenna 23, preferably integrated. An antenna 24 positioned in the car is connected to a receiver 25 which in turn is connected to a control unit 26 which is connected to the vehicle communication system 27 of the car. The vehicle communication system 27 can, via an antenna 28, communicate with an alarm centre (not shown).

FIG. 4 shows schematically a second embodiment of the emergency call system according to the present invention. The emergency call system 30 according to this second embodiment differs from the above-described first embodiment by the control unit 26 being adapted to obtain safety-related signals 31a-f from sensors located in the car.

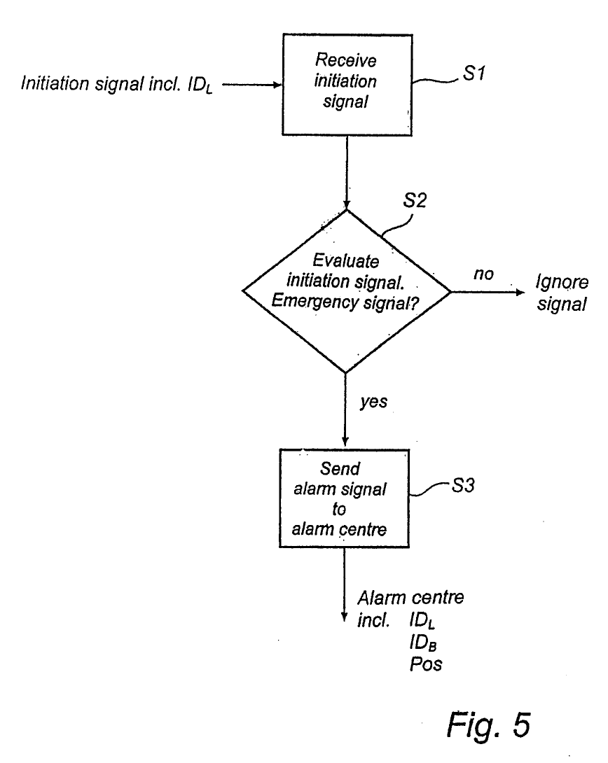

FIG. 5 illustrates schematically a first embodiment of a method according to the present invention, according to which in a first step S1 an initiation signal together with an identification code ID_{L} belonging to an alarm unit is received. In the next step S2, the initiation signal is evaluated to establish whether the signal is an emergency signal or only some other type of signal at the frequency band in question (for instance a signal to unlock a car). If the initiation signal is assessed to be a valid emergency signal, the step S3 of sending an alarm signal to an alarm centre is performed. Otherwise, the signal is ignored. Included in the alarm signal, preferably the identification code ID_{L} of the alarm unit, the identification code ID_{B} of the car and also the position of the car are transmitted. If the car is equipped with a GPS navigation system, the exact position of the car can be transmitted. If the car has no GPS system, information about the GSM cell in question or the like can be sent instead.

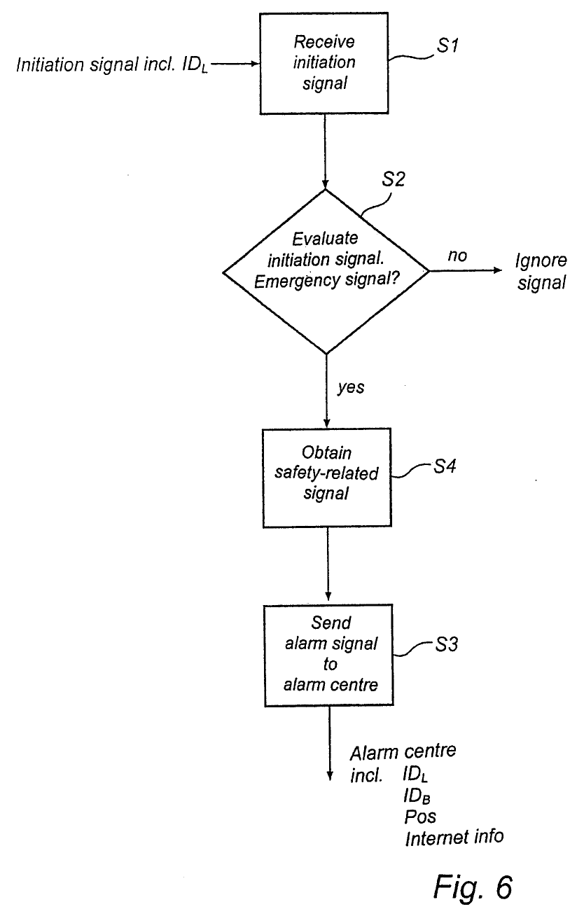

FIG. 6 illustrates schematically a second embodiment of a method according to the present invention, which differs from the first embodiment described above by a step S4 of obtaining at least one safety-related signal being added. Safety-related signals can be, for instance, at least one of belt stretching signal, acceleration sensor signal, temperature signal, airbag signal, tyre pressure signal and engine status signal. Of course, also other signals are conceivable. Additional information about the emergency can be sent to the alarm centre by means of one or more of these signals.

A person skilled in the art realises that a number of additional variants and modifications of the embodiments described are possible within the scope of the appended claims. For example, the alarm unit, of course, need not be connected to a specific vehicle, but can be associated with an individual and adapted to send an initiation signal that is perceived as an emergency signal by the emergency call system.

1. A method for an emergency call from a vehicle to an alarm centre, comprising the steps of
receiving (S1) a wireless initiation signal from a portable alarm unit (11), said wireless initiation signal comprising an identification code (ID_{L}) which identifies the alarm unit (11);
evaluating (S2) said initiation signal; and
sending (S3), based on the result of said evaluation, a wireless alarm signal (13a-b) from a vehicle communication system (27) arranged in the vehicle (12a-b) to the alarm centre,
the step (S2) of evaluating said initiation signal comprising the steps of
identifying said initiation signal as an emergency signal; and
allowing emission of a wireless alarm signal (13a-b) in response to a wireless initiation signal from each of a plurality of portable alarm units (11), said alarm units (11) having different identities (ID_{L}).

2. A method as claimed in claim 1, wherein emission (S3) of a wireless alarm signal (13a-b) is allowed in response to a wireless initiation signal from a portable alarm unit (11) which is related to another vehicle.

3. A method as claimed in claim 1 or 2, further comprising the step (S4) of obtaining a safety-related signal (31a-f) from a sensor located in the vehicle (12a-b).

4. A method as claimed in claim 3, wherein said step (S2) of evaluating said initiation signal further comprises the step of evaluating said safety-related signal (31a-f) in order to thus obtain information about an emergency.

5. A method as claimed in any one of the preceding claims, wherein said alarm signal (13a-b) comprises information about at least one of the position of the vehicle (12a-b), the identity of the vehicle (ID_{B}), the identity of the alarm unit (ID_{L}) and the emergency.

6. An emergency call system (19; 30) for vehicles, comprising a receiver (25) located in a vehicle (12a-b) and adapted to receive a wireless initiation signal from a portable alarm unit (11), a control unit (26) connected to the receiver (25) and adapted to send, after evaluation of said initiation signal, an alarm command to a vehicle communication system (27), the vehicle communication system (27) being adapted to send, in response to said alarm command, a wireless alarm signal to an alarm centre, said wireless initiation signal comprising an identification code (ID_{L}) which identifies the alarm unit (11), and said control unit (26) being adapted to send an alarm command to said vehicle communication system (27) in response to a wireless initiation signal from each of a plurality of portable alarm units (11) with different identities (ID_{L}).

7. An emergency call system (19; 30) as claimed in claim 6, wherein said control unit (26) is adapted to send an alarm command to said vehicle communication system (27) in response to a wireless initiation signal from a portable alarm unit (11) which is related to another vehicle.

8. An emergency call system (19; 30) as claimed in claim 6 or 7, wherein said control unit (26) is further adapted to obtain a safety-related signal (31a-f) from a sensor located in the vehicle (12a-b).

9. An emergency call system (19; 30) as claimed in claim 8, wherein said control unit (26) is further adapted to evaluate said safety-related signal (31a-f) in order to thus obtain information about an emergency.

10. An emergency call system (19; 30) as claimed in any one of claims 6-9, wherein said alarm signal (13a-b) comprises information about at least one of the position of the vehicle (12a-b), the identity of the vehicle (ID_{B}) , the identity of the alarm unit (ID_{L}) and the emergency.
